(19) United States
(12) Patent Application Publication
(10) Pub. No.: US 2008/0226946 A1
(43) Pub. Date: Sep. 18, 2008

(54) Magnetic disc, stamper for making magnetic disc, and method for making magnetic disc

(75) Inventors: Mineo Moribe, Kawasaki (JP); Takahiro Umada, Kawasaki (JP); Yasuo Hosoda, Tsurugashima-shi (JP); Kazunobu Hashimoto, Tsurugashima-shi (JP); Masahiro Katsumura, Tsurugashima-shi (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); PIONEER CORPORATION, Tokyo (JP)

(21) Appl. No.: 12/076,360

(22) Filed: Mar. 17, 2008

(30) Foreign Application Priority Data
Mar. 15, 2007 (JP) 2007-066243

(51) Int. Cl. G11B 5/127; G11B 5/84

(52) U.S. Cl. 428/810; 425/385; 216/22

(57) ABSTRACT

A magnetic disc has a data area including a magnetic data zone and nonmagnetic portions for physically separating the magnetic data zone, and also has a servo area provided with a magnetic pattern made up of magnetic portions and nonmagnetic portions. The servo area includes a belt-like area elongated in a radial direction of the magnetic disc and having a circumferential length at least twice as long as a unit length readable by a magnetic head in a circumferential direction of the magnetic disc. The belt-like area is provided with magnetic regions and nonmagnetic regions alternating with each other in the radial direction of the disc, where each of the magnetic and nonmagnetic regions extends from the first end to the second end of the belt-like area that are spaced from each other in the circumferential direction of the disc.

### BACKGROUND OF THE INVENTION

1. Field of the Invention

The present invention relates to magnetic discs suitable for so called discrete track media and patterned media, a stamper for making a magnetic disc, and a method for making a magnetic disc.

2. Description of the Related Art

Magnetic discs are a popular recording medium for constituting a memory device such as a hard disc. In association with ever increasing amount of information processed by computer systems, there is an increasing demand for magnetic discs which have an increased recording density.

In the field of magnetic discs, discrete track medium (DTM) and patterned medium (PM) are known as preferred media for increased recording density.

The magnetic disc has tracks formed in a concentric manner. Each of the tracks is divided circumferentially into unit sectors. FIG. 9 shows an example of sector structure of a conventional magnetic disc provided by a DTM. Each sector S is provided with a servo area 91 for positioning the magnetic head, and a data area 92 for recording data.

The servo area 91 includes a preamble section 911, a servo mark section 912, an address mark section 913 and a phase pattern section 914. These sections have a magnetic pattern made up of magnetic portions and nonmagnetic portions. In FIG. 9, the nonmagnetic portions are indicated by hatching. As viewed circumferentially of the disc (a direction indicated by Arrow X), the magnetic portion and the nonmagnetic portion have a length (circumferential length) long enough to permit the magnetic head to read data. In the preamble section 911 and the phase pattern section 914, the magnetic portions and the nonmagnetic portions have substantially the same circumferential length, and the nonmagnetic portions account for about 50% of the area. On the other hand, the servo mark section 912 and the address mark section 913 include belt-like nonmagnetic areas 912A, 913A having a relatively large circumferential length. In this place, the nonmagnetic portions account for about 75 through 83% of the area. As understood, the servo area 91 is formed with a predetermined magnetic pattern provided by magnetic portions and nonmagnetic portions. When information is recorded to or reproduced from the magnetic disc, the positioning of the magnetic head is achieved on the basis of various signals obtained in the servo area 91. It should be noted here that in the servo area 91, the magnetic portions and the nonmagnetic portions may be exchanged with each other, so that the area will have a reversed pattern of the one shown in FIG. 9. In that case, the magnetic head can obtain necessary signals to perform proper positioning of the head.

The data area 92 includes a magnetic data zone 921, and nonmagnetic guard bands 922 extending circumferentially for physically dividing the data zone 921 into adjacent tracks TR. In the data area 92, the nonmagnetic portions account for about 40% of the area, for example.

The above-described conventional magnetic disc is manufactured by e.g. nanoimprint lithography (See JP-A-2006-99904 for example). In this method, first, a stamper is made. When making the stamper, a resist pattern is formed by patterning a resist film on a silicon substrate for example, by electron lithography. The resist pattern has a pattern for forming the magnetic portions in the magnetic disc. Next, using this resist pattern as a mask, etching is performed to a silicon substrate to form a recessed pattern, and then the resist pattern is removed. Next, electroforming is performed to the recessed silicon substrate, to obtain a stamper made of metal such as nickel. The stamper has a predetermined engraving pattern which has ridges to form nonmagnetic portions of the magnetic disc.

Next, the stamper is pressed onto a resist under heat for example. The resist is made of a thermoplastic resin and is formed on a magnetic film that constitutes the magnetic disc. In this process, the engraving pattern on the stamper is embossed to the resist in a single process. Thus, the resist is formed with recesses correspondingly to the ridges on the stamper. Next, residual resist in the recesses are removed by oxygen plasma ashing for example, and then etching is performed to the magnetic film using the resist pattern (ridge portions of the resist) as a mask, whereby exposed portions of the magnetic film is etched off to become recesses. These recesses will form nonmagnetic portions in the above-described servo area 91 and the data area 92, whereas un-etched ridges left between the recesses in the magnetic film will form magnetic portions in the servo area 91 and the data area 92. The recesses in the magnetic film are then filled with nonmagnetic material to make a flat surface.

According to the method of making DTM magnetic discs by nanoimprint lithography as described, it is possible to obtain a stamper which has a microstructure in the order of 10 nm or less because of the use of electron lithography in the making of the stamper. Further, through the use of this stamper, it is possible to form a highly accurate pattern of nonmagnetic portions in a single step.

However, in the manufacture of the above-described magnetic discs, there has been the following problem. Specifically, FIG. 10(a) shows a situation where a disc substrate 961 has a magnetic film 962 formed with a resist 963 thereon, and a stamper 951 is positioned to face the resist 963. The stamper 951 has an area 951C which corresponds to the preamble 911 and the phase pattern 914 of the servo area 91 as well as the data area 92. In the area 951C, ridges 951a account for about 40 through 50% of the area. On the other hand, the stamper 951 has an area 951D which corresponds to the belt-like areas 912A, 913A and their surrounds. In this area 951D, the ridges 951a account for about 75 through 83%, i.e. the area ratio is substantially higher than in the area 951C.

FIG. 10(b) shows an initial phase of a step of pressing the stamper 951 onto the resist. As the ridges 951a of the stamper 951 are pressed in, some of the resist 963 displaced by the ridges 951a moves into the recesses 951b of the stamper 951. Now, in the area 951D where the ridges 951a account for a relatively large percentage of the area, the recesses 951b are filled fully with the resist 963. The resist 963, which is formed of a thermoplastic resin, has a relatively poor flowability. For this reason, pressing the stamper 951 further from this state does not drive the ridges 951a further in the area 951D. On the other hand, in the area 951C where the ridges 951a account for a relatively small percentage of the area, the recesses 951b still have spaces and therefore it is possible to drive the stamper 951 further. Therefore, as the stamper 951 is pressed, the ridges 951a are driven further into the resist 963 in the area 951C as shown in FIG. 10(c). By driving the stamper 951 sufficiently into the resist 963 as described, the embossing of the engraving pattern from the stamper 951 to the resist 963 is completed.

FIG. 10(d) shows a state where the stamper 951 has been removed. Note here, that because the depth to which the stamper was driven differs from one place to another of the stamper surface, the thickness of the residual resist remaining on the magnetic film 962 differs from one place to another. In other words, a thickness T3 of the residual resist in the range corresponding to the area 951C is smaller than a thickness T2 of the residual resist in the range corresponding to the area 951D. In the next step shown in FIG. 10(e), the residual resist is removed by ashing, in order to expose the surface of the magnetic film 962. In this step, partial erosion to adjacent ridges 963a can occur in the resist 963 in areas where the thickness of the residual resist is small, resulting in undue exposure of the surface of the magnetic film 962. If this occurs, the pattern of the ridges 963a becomes defective, and as a result, the pattern of the recesses to be formed in the magnetic film 962 by etching in the next step also becomes defective due to the use of the ridges 963a as a mask. Unfavorably, such a defective magnetic pattern adversely affects the data recoding and reproducing of the magnetic disc.

### SUMMARY OF THE INVENTION

The present invention has been proposed under the above-described circumstances. It is therefore an object of the present invention to provide a magnetic disc having a stable magnetic pattern that is not adversely affected by nanoimprint lithography. Other objects of the present invention are to provide a stamper suitable for making such a magnetic disc, and to provide a method of making such a magnetic disc.

According to a first aspect of the present invention, there is provided a magnetic disc comprising: a data area including a magnetic data zone and nonmagnetic portions for physically separating the magnetic data zone; and a servo area provided with a magnetic pattern made up of magnetic portions and nonmagnetic portions. The servo area includes a belt-like area elongated in a radial direction of the magnetic disc, where the belt-like area has a circumferential length at least twice as long as a unit length readable by a reading head element of a magnetic head in a circumferential direction of the magnetic disc, while also having a first end and a second end spaced from each other in the circumferential direction. The belt-like area is provided with magnetic regions and nonmagnetic regions alternating with each other in the radial direction, where each of the magnetic regions and the nonmagnetic regions has a predetermined width and extends from the first end to the second end of the belt-like area.

Preferably, the nonmagnetic portions in the data area may be elongated in the circumferential direction of the magnetic disc to serve as guard bands for physically dividing the data zone into a plurality of tracks. When having such a structure, the magnetic disc is referred to as a discrete track media.

Preferably, the nonmagnetic portions in the data area may be configured to physically separate data bits. In this case, the the magnetic disc is said to have a bit-patterned structure.

Preferably, the sum of the width of each magnetic region and the width of each nonmagnetic region may be smaller than the radial length of the reading head element.

Preferably, the magnetic disc of the present invention may further comprise magnetic portions sandwiching the belt-like area in the circumferential direction of the magnetic disc. In this case, the width of each magnetic region is smaller than the width of each nonmagnetic region.

Alternatively, the magnetic disc of the present invention may further comprise nonmagnetic portions sandwiching the belt-like area in the circumferential direction of the magnetic disc. In this case, the width of each nonmagnetic region is smaller than the width of each magnetic region.

In a preferred embodiment of the present invention, the servo area includes a first and a second belt-like areas sandwiched by magnetic portions in the circumferential direction of the magnetic disc, where the first belt-like area is greater in circumferential length than the second belt-like area, and each of the magnetic regions in the first belt-like area is greater in width than each of the magnetic regions in the second belt-like area.

Alternatively, the servo area may include a first and a second belt-like areas sandwiched by nonmagnetic portions in the circumferential direction of the magnetic disc, where the first belt-like area is greater in circumferential length than the second belt-like area, and each of the nonmagnetic regions in the first belt-like area is greater in width than each of the nonmagnetic regions in the second belt-like area.

According to a second aspect of the present invention, there is provided a stamper used for making a magnetic disc by nanoimprint lithography. The stamper comprises: a pattern of ridges and recesses corresponding in position to the belt-like area in the servo area of the magnetic disc according to the above first aspect; and additional recesses sandwiching the combination of ridges and recesses.

According to a third aspect of the present invention, there is provided a method of making a magnetic disc, wherein the method comprises: forming a magnetic film on a substrate; forming a resist on the magnetic film; pressing the stamper mentioned above onto the resist to transfer the pattern of ridges and recesses to the resist; forming a mask by partially removing the resist after the transfer until the magnetic film is partially exposed; and etching the magnetic film by using the mask.

According to a fourth aspect of the present invention, there is provided a method of making a magnetic disc, where the method comprises: forming a resist on a substrate; pressing the stamper mentioned above onto the resist to transfer the pattern of ridges and recesses to the resist; forming a mask by partially removing the resist after the transfer until the substrate is partially exposed; forming a magnetic film on mask and the substrate; and removing part of the magnetic film on the mask by a lift-off process.

Other features and advantages of the present invention will become clearer from the following detailed description to be made with reference to the drawings.

### BRIEF DESCRIPTION OF THE DRAWINGS

FIG. 1 is a plan view showing a magnetic disc according to the present invention.

FIG. 2 is an enlarged partial plan view showing the sector structure of the magnetic disc in FIG. 1.

FIG. 3 is an enlarged partial sectional view showing a method of making a stamper.

FIG. 4 is an enlarged partial sectional view showing steps in a method of making a magnetic disc according to the present invention.

FIG. 5 is an enlarged partial sectional view showing steps following those shown in FIG. 4.

FIG. 6 is an enlarged partial plan view showing another example of sector structure of the magnetic disc according to the present invention.

FIG. 7 is an enlarged partial sectional view showing steps in a method of making the magnetic disc in FIG. 6.

FIG. 8 is an enlarged partial sectional view showing steps following those shown in FIG. 7.

FIG. 9 is an enlarged partial plan view showing a sector structure of a conventional magnetic disc as a discrete track medium.

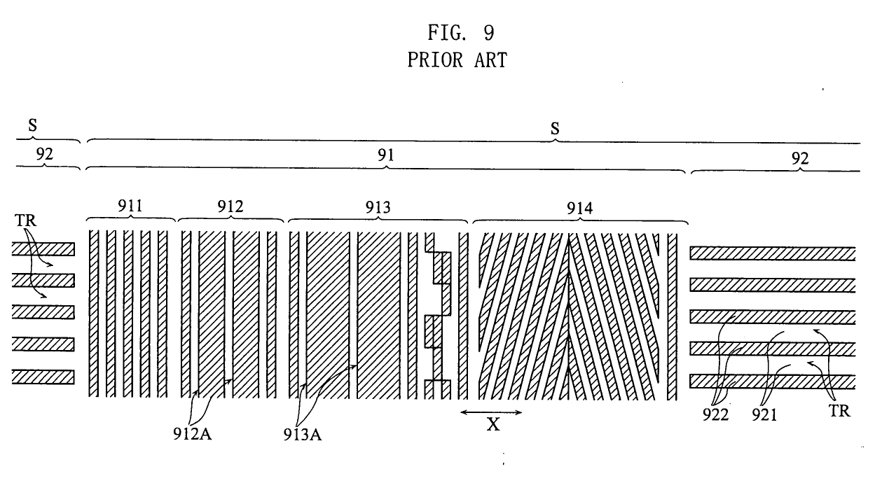

FIG. 10 is an enlarged partial sectional view showing steps in a method of making the conventional magnetic disc.

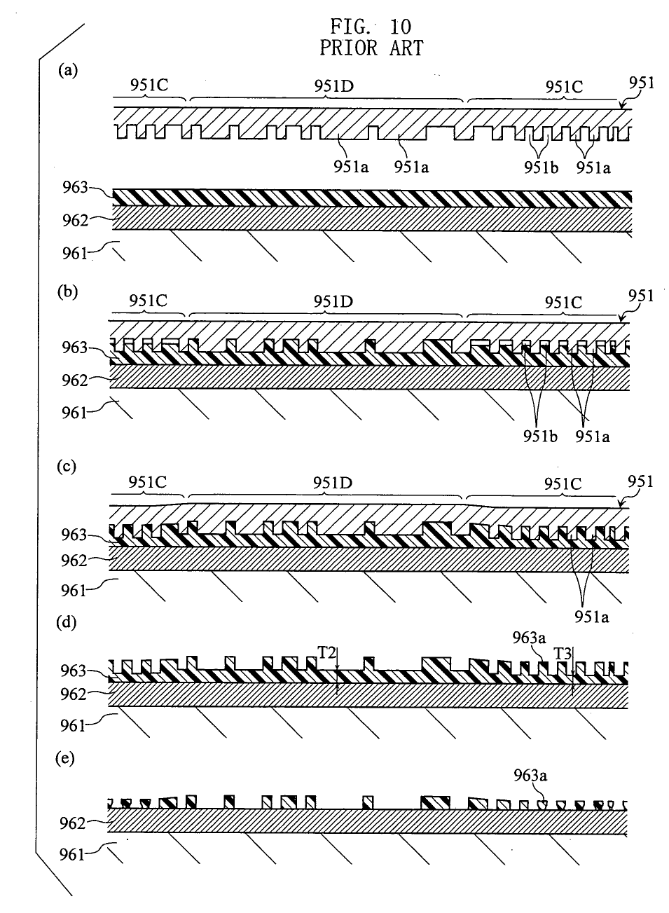

### DETAILED DESCRIPTION OF THE PREFERRED EMBODIMENTS

Preferred embodiments of the present invention will be described below with reference to the drawings.

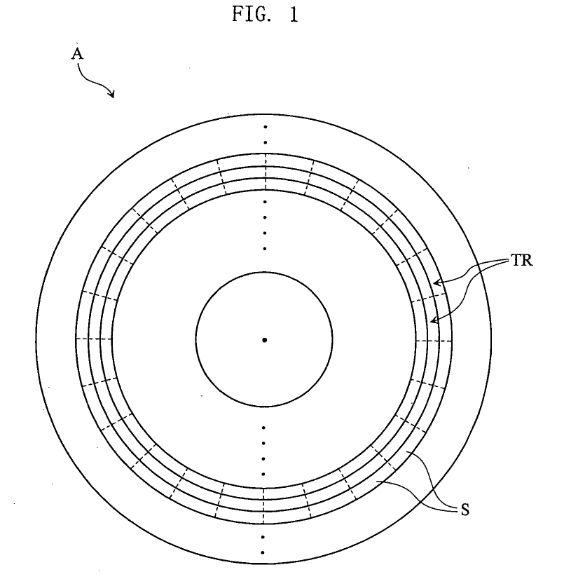

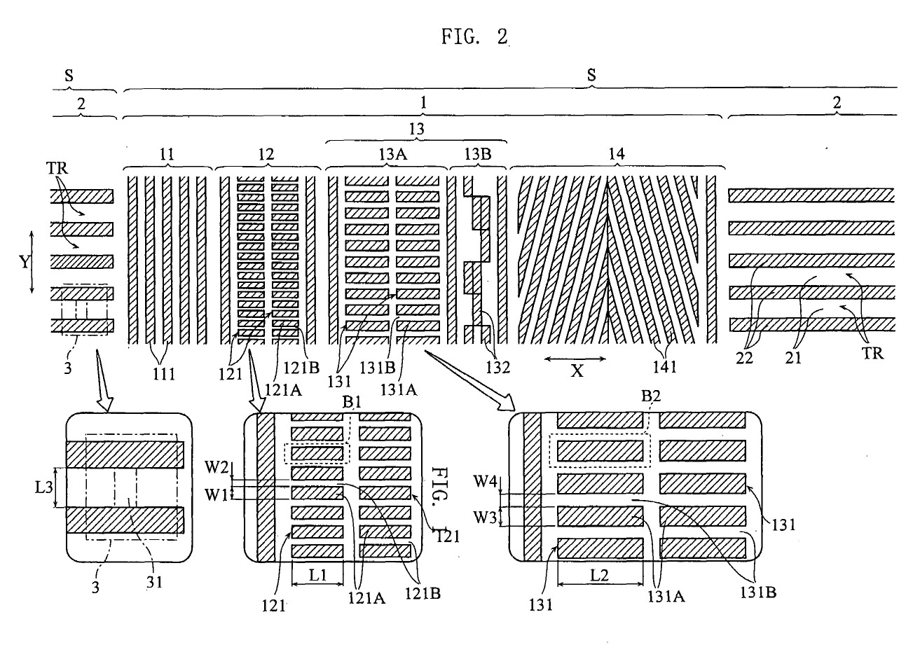

As shown in FIG. 1 and FIG. 2, the magnetic disc A has a plurality of concentric tracks TR formed by magnetic portions and nonmagnetic portions, and serves as a discrete track medium. Each track TR, which is provided in a recording layer formed on a rigid disc substrate, is divided circumferentially into individual units or sectors S. Each sector S is provided with a servo area 1 for use in positioning the magnetic head 3, and a data area 2 for magnetically recording data.

The servo area 1 includes, for example, a preamble section 11, a servo mark section 12, an address mark section 13 and a phase pattern section 12. These sections have a magnetic pattern made up of magnetic portions and nonmagnetic portions. The magnetic pattern needs to be readable by a reading head element 31 of the magnetic head 3 at the time of recording/reproducing information to/from the magnetic disc A. For this reason, the magnetic portion and the nonmagnetic portion in the magnetic pattern are given a length in the disc's circumferential direction (indicated by Arrow X) equal to an integral multiple of the minimum circumferential length (hereinafter will be called base unit length) which can be read by the reading head element 31. The base unit length varies depending on the radial position on the disc, from 80 to 200 nm for example. In addition, the base unit length may differ depending on the design of the magnetic head 3, and operating conditions such as the number of revolutions of the magnetic disc A. In FIG. 2, the nonmagnetic portions are indicated by hatching.

The preamble section 11 is used for clock synchronization, and has linear portions 111 which extends radially of the disc (direction indicated by Arrow Y) so that they will give the same signal whichever track TR is approached by the magnetic head 3. The linear portions 111 are nonmagnetic portions, and are sandwiched by magnetic portions as viewed circumferentially of the disc. The linear portions 111 have a circumferential length which is substantially the same as the base unit length. The space between the linear portions 111 is substantially the same as the base unit length. Therefore, the nonmagnetic portions account for about 50% of the area in the preamble section 11.

The servo mark section 12 is provided for indicating the existence of the servo area 1, and has belt-like areas 121 each extending in the radial direction. The belt-like areas 121 are disposed side by side to be sandwiched by magnetic portions in the circumferential direction. The belt-like areas 121 have a circumferential length L1 which may be twice as great as the base unit length or longer. FIG. 2 shows a case where the circumferential length L1 is three times the base unit length. The belt-like areas 121 are made up of nonmagnetic regions 121A and magnetic regions 121B alternating with each other in the radial direction. Each nonmagnetic area 121A and each magnetic area 121B extend from one circumferential end to the other of the belt-like area 121, to have a predetermined width. The magnetic regions 121B have a width W2 which is narrower than a width W1 of the nonmagnetic regions 121A. The nonmagnetic portions in the servo mark section 12 account for about 50% of the area, for example (See an area surrounded by broken lines B1 in FIG. 2). Further, the total of the width W1 and the width W2 is not greater than a radial length L3 of the reading head element 31 of the magnetic head 3. This arrangement allows the reading head element 31 to read the belt-like area 121 wherever the magnetic head 3 is located in the disc radial direction.

The address mark section 13 indicates a sector number and a track number of a sector S where recording or reproduction is to be performed. The sector number is indicated by a sector number area 13A which includes a combination of belt-like areas 131 extending in the radial direction. The belt-like areas 131 have a circumferential length L2 which may be twice the base unit length or longer. FIG. 2 shows a case where the circumferential length L2 is five times the base unit length. Like the belt-like areas 121 described above, the belt-like areas 131 are made up of nonmagnetic regions 131A and magnetic regions 131B alternating with each other. The magnetic regions 131B have a width W4 which is narrower than a width W3 of the nonmagnetic regions 131A. Also, the width W4 of the magnetic regions 131B is wider than the width W2 of the magnetic regions 121B in the belt-like areas 121. In the above arrangement, the nonmagnetic portions in the sector number area 13A account for about 50% of the area, for example (See the area surrounded by broken lines B2 in FIG. 2). Further, a total of the width W3 and the width W4 is not longer than the radial length L3 of the reading head element 31 of the magnetic head 3. This arrangement allows the reading head element 31 to read the belt-like area 131 wherever the magnetic head 3 is in the disc radial direction. The track number is indicated by a track number area 13B, which is a magnetic region patterned with relatively sparse nonmagnetic strips 132. The arrangement of the strips 132 is unique for each track TR. In the track number area 13B, the nonmagnetic portions account for about 50% of the area, for example.

The phase pattern section 12 is for conducting the magnetic head 3 to the center of the track TR, and is made up of a combination of linear portions 141 which extend diagonally to the disc's radial direction. The linear portions 141 are nonmagnetic portions sandwiched by magnetic portions in the circumferential direction. As viewed circumferentially (i.e., in the direction X), each of the linear portions 141 has a dimension (circumferential length) that is substantially the same as the distance between the adjacent linear portions 141. Accordingly, the nonmagnetic portions account for about 50% of the area in the phase pattern 14.

As described, the servo area 1 has a predetermined magnetic pattern made up of magnetic portions and nonmagnetic portions. When information is recorded/reproduced to/from the magnetic disc A, the positioning of the magnetic head 3 is achieved based on various signals obtained from the servo area 1.

The data area 2 is made up of a data zone 21 provided by magnetic portions, and guard bands 22 provided by nonmagnetic portions for physically dividing the data zone 21 into individual tracks TR. In other words, the guard bands 22 define the tracks TR. In the data area 2, the nonmagnetic portions account for about 40% of the area, for example.

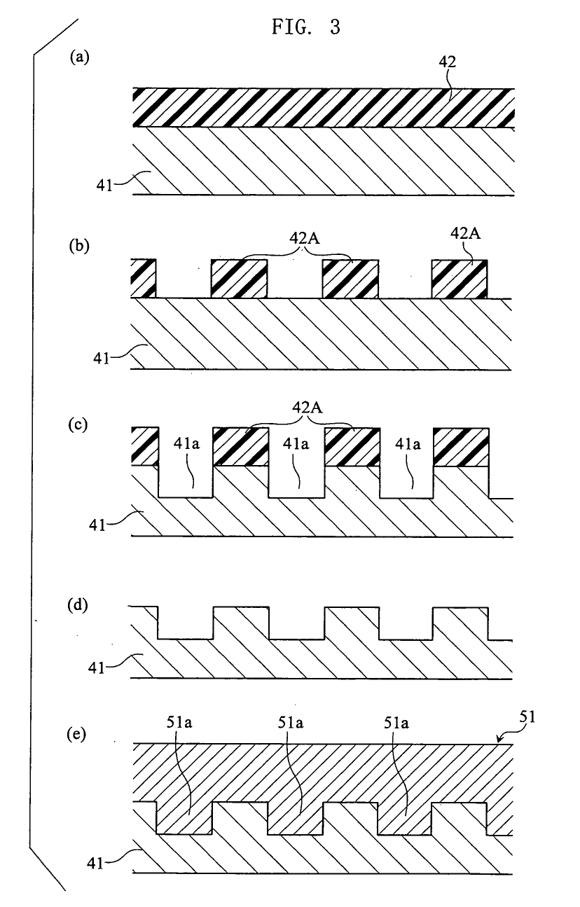

Next, a method of making the above-described magnetic disc A will be explained with reference to FIGS. 3 to 5.

The magnetic disc A is manufactured by nanoimprint lithography. In this method, first, a stamper is made. The process of making the stamper begins, as shown in FIG. 3(a), with forming of a resist film 42 on a disc-shaped silicon substrate 41 by a spin coating method for example. Next, as shown in FIG. 3(b), the resist film 42 is patterned by electron lithography for example, to form a resist pattern 42A. In this process of electron lithography, an electron beam lithography system for example, may be employed to form a predetermined pattern (latent image) in the resist film 42 in an electronic exposure process. The exposed resist film 42 is then developed, to become a resist pattern 42A. The resist pattern 42A has a pattern for forming the magnetic portions in the magnetic disc A. Next, as shown in FIG. 3(c), dry etching process such as RIE is performed to the silicon substrate 41 using the resist pattern 42A as a mask, to form recesses 41a. These recesses 41a form a pattern for forming nonmagnetic portions of the magnetic disc A. Next, as shown in FIG. 3(d), the resist pattern 42A is removed. The silicon substrate 41 with the recesses 41a formed as described above is a master matrix for the stamper. Next, as shown in FIG. 3(e), an electroforming process is performed to the silicon substrate 41, to obtain a stamper 51 which is made of metal such as nickel. The stamper 51 is formed with a combination of ridges and recesses the pattern of which has been transferred from the silicon substrate 41. Thus, the stamper 51 has a geometric engraving pattern, in which ridges 51a correspond to nonmagnetic portions in the magnetic disc A. As described above, the nonmagnetic portions account for about 40 through 50% in each zone in the servo area 1 and the data area 2. This means that the ridges 51a in each zone in the stamper 51 also account for about 40 through 50% of the area, and thus, area ratio differences of the ridges 51a are relatively small from one area to another.

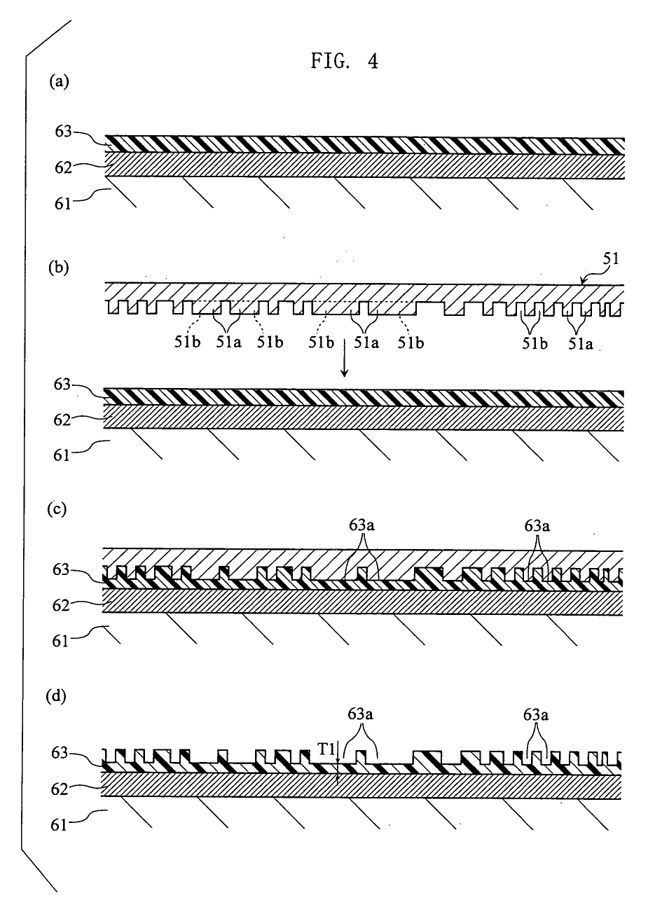

Next, as shown in FIG. 4(a), a magnetic film 62 and a resist 63 are formed sequentially on the disc substrate 61. The magnetic film 62, which is for later formation of the servo area 1 and the data area 2, is made of a magnetic material which has perpendicular magnetic anisotropy. An example of this magnetic material is CoCrPt—SiO₂. The resist 63 is made of a thermoplastic resin such as PMMA (polymethylmethacrylate). When a perpendicular recording method is used for the magnetic disc A, an unillustrated soft magnetic layer is provided between the disc substrate 61 and the magnetic film 62.

Next, the resist 63 is heated to a temperature not lower than the glass transition point, and the stamper 51 is pressed onto the resist 63 as shown in FIG. 4(b). Now, as the ridges 51a of the stamper 51 are pressed into the resist 63, portion of the resist 63 which is pushed away by the ridges 51a comes into recesses 51b in the stamper 51. Then, as shown in FIG. 4(c), as the recesses 51b have been filled with the resist 63, the pressing with the stamper 51 is stopped. In this process, the geometric pattern on the stamper 51 is transferred entirely to the resist 63, and recesses 63a are formed correspondingly to the ridges 51a of the stamper 51. Next, as shown in FIG. 4(d), the stamper 51 is removed from the resist 63. In the present embodiment, area ratio differences of the ridges 51a are relatively small among different areas on the stamper 51, and so the stamper 51 is pressed to a substantially uniform depth. As a result, the thickness T1 of residual resist on the magnetic film 62 also becomes substantially uniform.

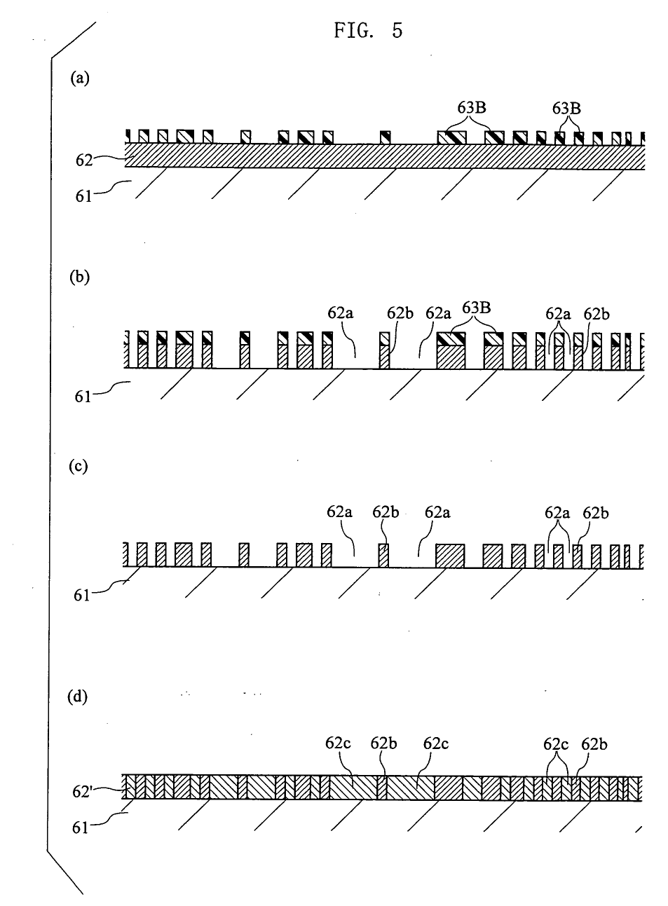

Next, as shown in FIG. 5(a), the residual resist is partially removed by oxygen plasma ashing for example until the magnetic film 62 is partially exposed. Next, as shown in FIG. 5(b), dry etching is performed to the magnetic film 62, using the resist pattern 63B (consisting of ridges in the resist 63) as a mask, to remove the exposed portions of the magnetic film 62 thereby forming recesses 62a. These recesses 62a define nonmagnetic portions in the servo area 1 and data area 2 whereas the ridges 62b remaining among the recesses 62a define magnetic portions in the servo area 1 and data area 2. Next, as shown in FIG. 5(c), the resist pattern 63B is removed by oxygen plasma ashing for example. Then, as shown in FIG. 5(d), recesses 62a are filled with a nonmagnetic material 62c, and the surface is flattened. Through these steps as described, a recording layer 62′ which has a servo area 1 and a data area 2 is formed. Next, a protective film is formed on the recording layer 62′ for example, to obtain a magnetic disc A.

According to the method of making the magnetic disc A offered by the present embodiment, area ratio differences of the ridges 51a among the areas on the surface of the stamper 51 are controlled to be relatively small so as to achieve a uniform thickness T1 of the residual resist. For this reason, the resist pattern 63B after the residue is removed has desired pattern integrity. Therefore, a desired magnetic pattern is formed by etching the magnetic film 62 using the resist pattern 63B as a mask. As a result, according to the magnetic disc A, it is possible to preserve integrity of the magnetic pattern, and to accomplish stable recording/reproducing.

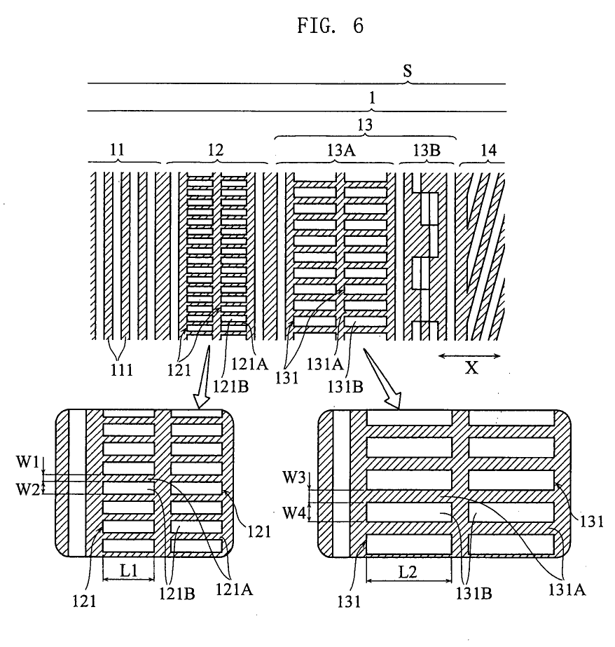

FIG. 6 shows another example of magnetic disc sector structure of the magnetic disc according to the present invention. It should be noted here that in FIG. 6 and thereafter, elements which are identical with or similar to those in the above-described embodiment will the indicated by the same reference symbols as in the previous embodiment, and their description will not be repeated. Note also, that nonmagnetic portions are indicated by hatching in FIG. 6.

As shown in FIG. 6, in the present embodiment, magnetic portions and nonmagnetic portions in the servo area 1 are formed in a reversed pattern of the pattern in the previous embodiment. Specifically, the belt-like areas 121, 131 are sandwiched by nonmagnetic portions in the disc's circumferential direction (direction X), and in the belt-like area 121, the nonmagnetic regions 121A has a width W1 which is narrower than a width W2 of the magnetic regions 121B. In the belt-like area 131, the nonmagnetic regions 131A have a width W3 which is narrower than a width W4 of the magnetic regions 131B. Likewise, the nonmagnetic regions 131A have a width W3 which is wider than the width W1 of the nonmagnetic regions 121A in the belt-like areas 121.

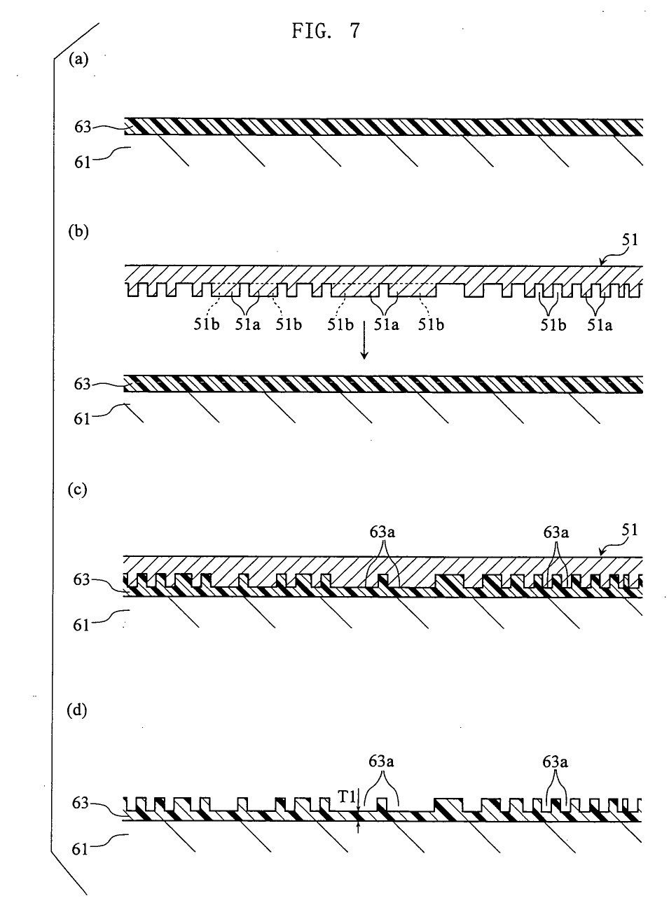

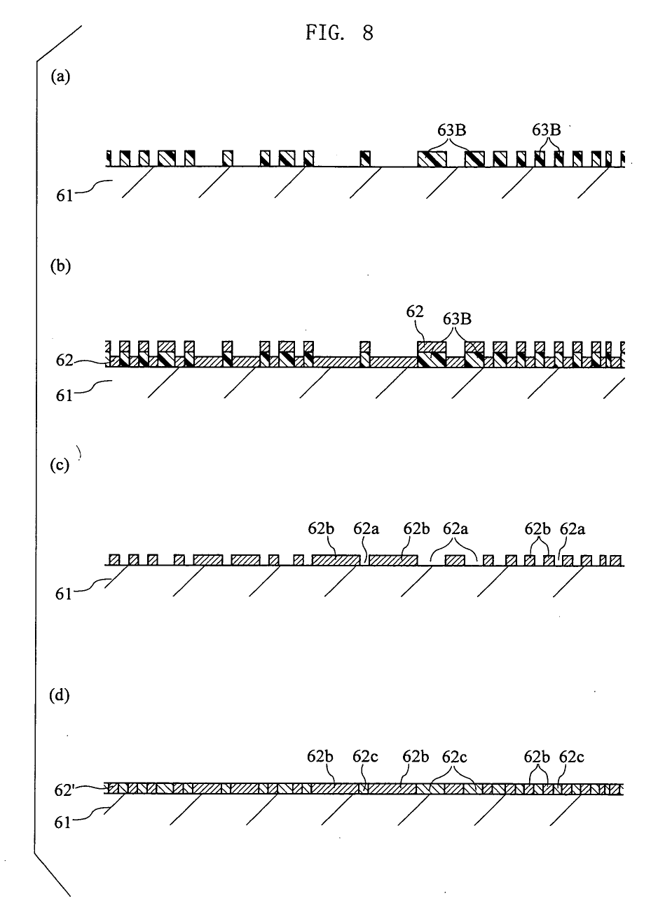

A method of making the above-described magnetic disc will be explained with reference to FIGS. 7 and 8.

In making the magnetic disc according to the present embodiment, a stamper 51 which is like the one used in the previous embodiment can be used. In making the magnetic disc, a resist 63 is formed on a disc substrate 61 as shown in FIG. 7 (a). Next, with the resist 63 being heated to a temperature not lower than the glass transition point, the stamper 51 is pressed onto the resist 63 as shown in FIG. 7(b). In this process, as shown in FIG. 7(c), the engraving pattern on the stamper 51 is transferred entirely to the resist 63, and recesses 63a are formed correspondingly to the ridges 51a of the stamper 51. Next, as shown in FIG. 7(d), the stamper 51 is removed from the resist 63. In the present embodiment again, area ratio differences of the ridges 51a among different areas on the stamper 51 are relatively small, and therefore the stamper 51 is pressed to a substantially uniform depth. As a result, the thickness T1 of the residual resist on the magnetic film 62 also becomes substantially uniform.

Next, as shown in FIG. 8(a), the residual resist is partially removed by oxygen plasma ashing for example, until the surface of the disc substrate 61 is partially exposed. Next, a lift-off process is employed to form a magnetic region which has the reverse pattern of the resist pattern 63. Specifically, as shown in FIG. 8(b), a magnetic film 62 is formed on the resist pattern 63B (consisting of ridges in the resist 63) and on the exposed surface of the disc substrate 61 by vapor deposition. Then, the resist pattern 63 is swollen and lifted by applying organic solvent for example. Then, as shown in FIG. 8(c), the resist pattern 63 and part of the magnetic film 62 formed thereon are removed to form recesses 62a. These recesses 62a define nonmagnetic portions whereas the ridges 62b remaining among the recesses 62a define magnetic portions. As will be understood by comparison to the previous embodiment shown in FIG. 5(c), the magnetic portions and the nonmagnetic portions are exchanged with each other, resulting in a reversed pattern. Next, as shown in FIG. 8(d), the recesses 62a are filled with a nonmagnetic material to provide a flattened surface. Then, a protective film is formed thereon.

According to the method of making the magnetic disc offered by the present embodiment, the stamper 51 which has substantially the same structure is used, and therefore area ratio differences of the ridges 51a among different areas on the surface of the stamper 51 are relatively small, so that the thickness T1 of the residual resist can be made uniform. For this reason, the resist pattern 63B after the residue is removed has desired pattern integrity. In addition, by using a lift-off process, a desired magnetic pattern which has a reverse pattern of the resist pattern 63 is formed. As a result, according to the magnetic disc offered by the present embodiment, it is also possible, as is in the magnetic disc A offered by the previous embodiment, to preserve integrity in the magnetic pattern, and to accomplish stable recording/reproducing.

Embodiments of the present invention being described thus far, the scope of the present invention is not limited to these embodiments. Specifics of the magnetic disc and of the stamper which is used for making the magnetic disc may be varied in many ways within the spirit of the invention. For example, in the embodiments, belt-like areas 121, 131 are constituted by nonmagnetic regions 121A, 131A and magnetic regions 121B, 131B each having a rectangular shape along the circumferential direction. However, the shape may be different. Also, in the embodiment, data area configuration is of a so-called discrete track medium in which the data zone is divided by a guard band. However, the data area configuration may be of a so-called bit patterned medium in which the data zone is divided for each bit by a nonmagnetic portion.

1. A magnetic disc comprising:
a data area including a magnetic data zone and nonmagnetic portions for physically separating the magnetic data zone; and
a servo area provided with a magnetic pattern made up of magnetic portions and nonmagnetic portions;
wherein the servo area includes a belt-like area elongated in a radial direction of the magnetic disc, the belt-like area having a circumferential length at least twice as long as a unit length readable by a reading head element of a magnetic head in a circumferential direction of the magnetic disc, the belt-like area having a first end and a second end spaced from each other in the circumferential direction, the belt-like area being provided with magnetic regions and nonmagnetic regions alternating with each other in the radial direction, each of the magnetic regions and the nonmagnetic regions having a predetermined width and extending from the first end to the second end.

2. The magnetic disc according to claim 1, wherein the nonmagnetic portions in the data area are elongated in the circumferential direction of the magnetic disc to serve as guard bands for physically dividing the data zone into a plurality of tracks.

3. The magnetic disc according to claim 1, wherein the nonmagnetic portions in the data area are configured to physically separate data bits.

4. The magnetic disc according to claim 1, wherein a sum of the width of each magnetic region and the width of each nonmagnetic region is smaller than a radial length of the reading head element.

5. The magnetic disc according to claim 1, further comprising magnetic portions sandwiching the belt-like area in the circumferential direction of the magnetic disc, wherein the width of each magnetic region is smaller than the width of each nonmagnetic region.

6. The magnetic disc according to claim 1, further comprising nonmagnetic portions sandwiching the belt-like area in the circumferential direction of the magnetic disc, wherein the width of each nonmagnetic region is smaller than the width of each magnetic region.

7. The magnetic disc according to claim 1, wherein the servo area includes a first and a second belt-like areas sandwiched by magnetic portions in the circumferential direction of the magnetic disc, the first belt-like area being greater in circumferential length than the second belt-like area, each of the magnetic regions in the first belt-like area being greater in width than each of the magnetic regions in the second belt-like area.

8. The magnetic disc according to claim 1, wherein the servo area includes a first and a second belt-like areas sandwiched by nonmagnetic portions in the circumferential direction of the magnetic disc, the first belt-like area being greater in circumferential length than the second belt-like area, each of the nonmagnetic regions in the first belt-like area being greater in width than each of the nonmagnetic regions in the second belt-like area.

9. A stamper used for making a magnetic disc by nanoimprint lithography, the stamper comprising:
a pattern of ridges and recesses corresponding in position to the belt-like area in the servo area of the magnetic disc set forth in claim 1; and
additional recesses sandwiching the combination of ridges and recesses.

10. A method of making a magnetic disc, the method comprising:
forming a magnetic film on a substrate;
forming a resist on the magnetic film;
pressing the stamper set forth in claim 9 onto the resist to transfer the pattern of ridges and recesses to the resist;
forming a mask by partially removing the resist after the transfer until the magnetic film is partially exposed; and
etching the magnetic film by using the mask.

11. A method of making a magnetic disc, the method comprising:
forming a resist on a substrate;
pressing the stamper set forth in claim 9 onto the resist to transfer the pattern of ridges and recesses to the resist;
forming a mask by partially removing the resist after the transfer until the substrate is partially exposed;
forming a magnetic film on mask and the substrate; and
removing part of the magnetic film on the mask by a lift-off process.
